(19) United States
(12) Patent Application Publication
(10) Pub. No.: US 2009/0241975 A1
(43) Pub. Date: Oct. 1, 2009

(54) Hair brush

(75) Inventor: Makoto Nakakura, Nagahama (JP)

Correspondence Address: BACON & THOMAS, PLLC, 625 SLATERS LANE, FOURTH FLOOR, ALEXANDRIA, VA, 22314-1176, US

(73) Assignee: Panasonic Electric Works Co., Ltd., Osaka (JP)

(21) Appl. No.: 12/382,430

(22) Filed: Mar. 17, 2009

(30) Foreign Application Priority Data
Mar. 25, 2008 (JP) 2008-079121

(51) Int. Cl. A45D 24/16; B26B 21/40; B26B 21/00; A45D 24/10

(52) U.S. Cl. 132/120; 30/30; 30/123; 132/148

(57) ABSTRACT

In a hair brush including a handle having a longitudinal tip end portion, a teeth holding base portion is provided in the longitudinal tip end portion of the handle. A plurality of comb-shaped blades is overlapped to make sliding contact with each other, the comb-shaped blades having edges and being provided in the longitudinal tip end portion of the handle. A thinning member is provided to cover the edges of the comb-shaped blades, the thinning member having a plurality of first apertures. A driving unit for reciprocates at least one of the comb-shaped blades so as to clip hair strands introduced between the edges of the comb-shaped blades through the first apertures of the thinning member. An opening-and-closing member is provided to open and close the first apertures of the thinning member.

### FIELD OF THE INVENTION

The present invention relates to a hair brush with a thinning function.

### BACKGROUND OF THE INVENTION

As a unit for thinning hair strands, there is known a hair clipper disclosed in, e.g., Japanese Patent Laid-open Publication No. 55-47885 (JP55-47885A).

The hair clipper disclosed in JP55-47885A includes a clipper body having a comb-shaped fixed blade and a comb-shaped movable blade capable of reciprocating motion along the fixed blade. The hair clipper is configured to clip hair strands introduced between the fixed blade and the movable blade.

An attachment having a plurality of slits is mounted to the clipper body having the fixed blade and the movable blade to cover the same. The hair clipper selectively clips hair strands introduced through the slits, thus performing what is called thinning.

With the conventional hair clipper cited above, however, the attachment has a relatively small thickness. If the attachment is allowed to make surface-to-surface contact with the scalp, there is a fear that the distance between the scalp and the blade becomes too small, meaning that the hair strands remaining after clipping have an unduly short length.

In order to assure good finishing, therefore, it is desirable to perform a treatment while maintaining a suitable distance between the attachment and the scalp. This treatment requires an increased level of proficiency, which poses a problem in that an unaccustomed user is hard to use the hair clipper.

### SUMMARY OF THE INVENTION

In view of the above, the present invention provides an easy-to-use hair brush capable of thinning hair strands.

In accordance with an aspect of the invention, there is provided a hair brush including: a handle having a longitudinal tip end portion; a teeth holding base portion provided in the longitudinal tip end portion of the handle; a plurality of comb-shaped blades overlapped to make sliding contact with each other, the comb-shaped blades having edges and being provided in the longitudinal tip end portion of the handle; a thinning member provided to cover the edges of the comb-shaped blades, the thinning member having a plurality of first apertures; a driving means for reciprocating at least one of the comb-shaped blades so as to clip hair strands introduced between the edges of the comb-shaped blades through the first apertures of the thinning member; and an opening-and-closing member for opening and closing the first apertures of the thinning member.

With such configuration, the comb-shaped blades for thinning hair strands are provided together with the teeth holding base portion. Therefore, the brush teeth or bristles upstanding from the teeth holding base portion make it easy to secure the distance from the comb-shaped blades to the scalp. When the hair brush is used for the sole purpose of brushing the hair without having to thin the same, the apertures of the thinning member are closed by the opening-and-closing member. This makes it possible to smoothly move the hair brush.

It is preferable that the hair brush further includes a slide support mechanism for supporting the opening-and-closing member so as to slide along the thinning member.

With such configuration, it is possible to reduce the space through which the opening-and-closing member is moved within the teeth holding base portion.

Preferably, the opening-and-closing member has a plurality of second apertures, the second apertures being arranged to ensure that, when the opening-and-closing member is slid into a specified position, some of the first apertures overlap with the second apertures so as to come into an open state and the remaining first apertures are closed by the opening-and-closing member.

With such configuration, it is possible to control the thinning amount or clipping rate of the hair by selectively opening the first apertures of the thinning member.

Preferably, the hair brush further includes an opening degree adjusting mechanism for variably setting the opening degree of the first apertures.

With such configuration, it is possible to control the thinning amount or clipping rate of the hair by changing the opening degree of the first apertures of the thinning member.

Preferably, the hair brush further includes a switch with an operation knob for switching the operation of the driving unit and an interlocking mechanism for operatively interconnecting the operation knob of the operation switch and the opening-and-closing member and the opening-and-closing member is configured to move at least between an open position in which to open the first apertures and a closed position in which to close the first apertures.

With such configuration, the operative connection of the opening-and-closing member with the operation knob enables the comb-shaped blade to be suitably operated depending on the open-and-closed state of the first apertures.

### BRIEF DESCRIPTION OF THE DRAWINGS

The objects and features of the present invention will become apparent from the following description of embodiments, given in conjunction with the accompanying drawings, in which:

FIG. 1 is a perspective view showing a hair brush with a thinning function in accordance with an embodiment of the present invention;

FIG. 2 is a perspective view showing a main body and an opening-and-closing member in an exploded state, both of which are employed in the hair brush with a thinning function in accordance with the embodiment of the present invention;

FIG. 3 is a perspective view showing an attachment included in the hair brush with a thinning function in accordance with the embodiment of the present invention;

FIG. 4 is a plan view showing the attachment included in the hair brush with a thinning function in accordance with the embodiment of the present invention;

FIG. 5 is a section view showing the attachment included in the hair brush with a thinning function in accordance with the embodiment of the present invention;

FIGS. 6A, 6B and 6C are views illustrating the operation states of the opening-and-closing member included in the hair brush with a thinning function in accordance with the embodiment of the present invention;

FIG. 7 is a view depicting one exemplary use of the hair brush with a thinning function in accordance with the embodiment of the present invention; and

FIGS. 8A through 8C are schematic diagrams illustrating the open-and-closed states of the apertures in a modified example of the hair brush with a thinning function.

### DETAILED DESCRIPTION OF THE PREFERRED EMBODIMENTS

Hereinafter, an embodiment of the present invention will be described with reference to the accompanying drawings which form a part hereof.

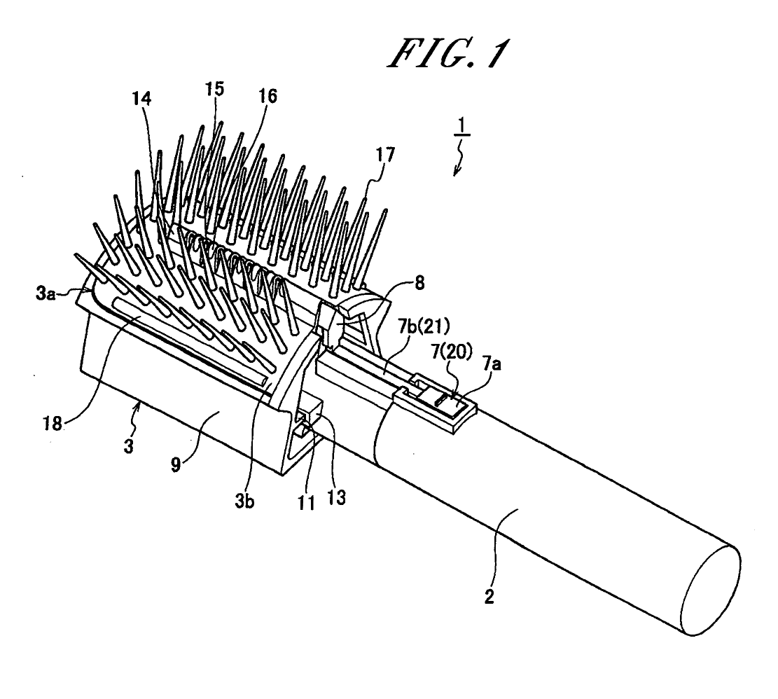

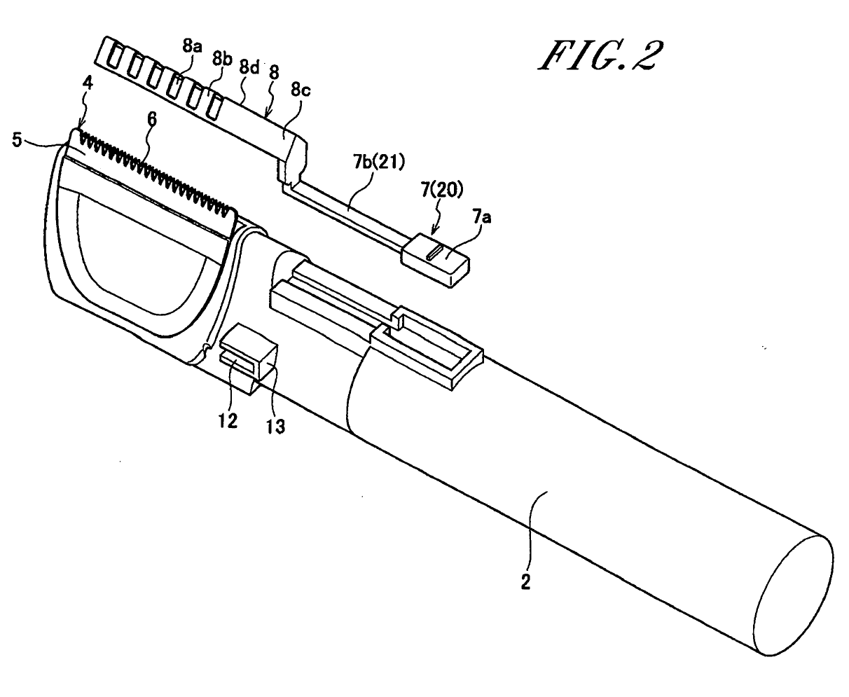

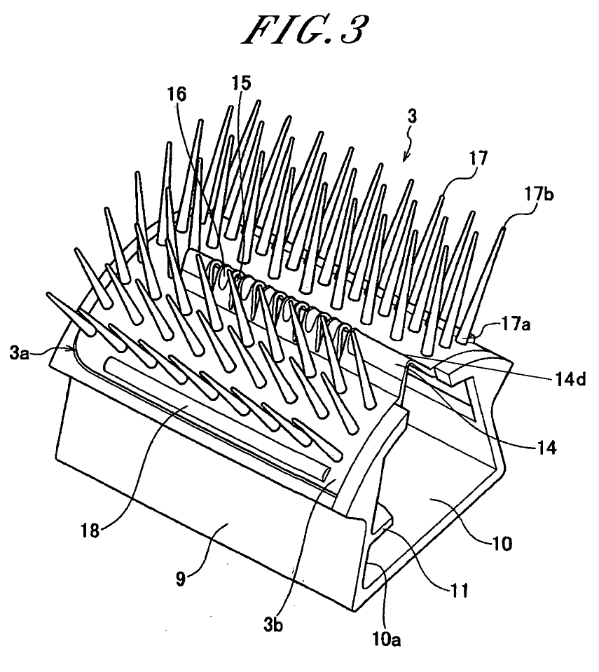

FIG. 1 is a perspective view showing a hair clipper with a thinning function (hereinafter referred to as “hair brush”) in accordance with the embodiment of the present invention. FIG. 2 is a perspective view showing a main body and an opening-and-closing member of the hair brush in an exploded state. FIGS. 3, 4 and 5 are perspective, plan and section views showing an attachment.

Referring to FIG. 1, the hair brush 1 includes a main body 2 of cylindrical elongated shape serving as a handle. An attachment 3 having brush teeth 17 is removably mounted to one longitudinal end portion of the main body 2.

As shown in FIG. 2, a hair clipper unit 4 is provided in one longitudinal end portion of the main body 2. The hair clipper unit 4 includes a fixed blade 5 fixedly secured to the main body 2 and a movable blade 6 for making sliding movement relative to the fixed blade 5. Each of the fixed blade 5 and the movable blade 6 is formed into a flat shape and is constructed from a comb-shaped blade (or a saw blade) having a plurality of teeth rectilinearly arranged along one side thereof. With the hair clipper unit 4, hair strands are inserted into the inter-teeth notches of the fixed blade 5 overlapping with the inter-teeth notches of the movable blade 6 and are clipped by the movable blade 6 reciprocating relative to the fixed blade 5.

The movable blade 6 is driven by a driving unit (e.g., a linear motor and a driving circuit thereof not shown in the drawings) provided in the main body 2 and a power source of the driving unit (e.g., a battery or the like). The operation of the driving device is changed over by an operation switch 7 provided in the substantially longitudinal center of the main body 2. The operation switch 7 has an operation knob 7a that can reciprocate along the longitudinal direction of the main body 2.

Referring to FIG. 3, the attachment 3 includes a block portion 9 mounted to the tip end portion of the main body 2. In the block portion 9, there is defined an accommodation space 10 for accommodating the hair clipper unit 4 provided in the tip end portion of the main body 2. On one inner wall surface 10a of the accommodation space 10, there is formed a rotation-preventing piece 11 that prevents the block portion 9 from rotating about an axis relative to the main body 2. The rotation-preventing piece 11 is formed in the shape of a tongue piece extending from the opening of the accommodation space 10 toward the interior thereof. The rotation-preventing piece 11 engages with a groove portion 12 (see FIG. 2) formed in the main body 2, thereby preventing the block portion 9 from rotating about the axis relative to the main body 2. The groove portion 12 is defined by a protrusion 13 protruding from one side surface of the main body 2, which has a substantially one side opened rectangular shape, i.e., a substantially inverted C-shaped when viewed from the side.

The attachment 3 is provided with a longitudinally-extending teeth holding base portion 3a having an arc-shaped cross section perpendicular to the longitudinal direction. The teeth holding base portion 3a has a substantially arc-shaped outer surface 3b on which a plurality of brush teeth 17 with a substantially constant height is arranged substantially uniformly. In the present embodiment, each of the brush teeth 17 is formed of an elongated conical body and has a diameter gradually decreasing from the base end portion 17a toward the tip end portion 17b thereof. The brush teeth 17 have elasticity (flexibility) such that they can be flexed when a force is applied thereto in the lateral direction.

The attachment 3 is further provided with a thinning member 14 for use in thinning the hair. The thinning member 14 is positioned in the substantially transverse central region of the teeth holding base portion 3a and is elongated in the longitudinal direction. The thinning member 14 includes two side plates 14a joined to each other in a ridge portion 14d to make an inverted V-shape (or a chevron shape) Thus the thinning member 14 covers the edges of the fixed blade 5 and the movable blade 6 in a spaced-apart relationship.

The thinning member 14 has a plurality of apertures 15 formed at a substantially uniform pitch. The apertures 15 are formed by cutting the side plates 14a into a deep notch shape so that the apertures 15 can extend from the ridge portion 14d toward their pointed ends. As shown in FIG. 4, each of the apertures 15 has a substantially rhombic shape when seen from above the ridge portion 14d. With this configuration, the hair strands introduced into the thinning member 14 through the apertures 15 are clipped by the hair clipper unit 4. In contrast, the hair strands coming into contact with blocking portions 16 provided between the apertures 15 are not clipped by the hair clipper unit 4.

In the transverse opposite edge portions of the outer surface 3b of the teeth holding base portion 3a, there are provided rubber members 18 as protrusions elongating along the longitudinal direction. The rubber members 18 serve to apply a tensile force to the hair strands, thereby urging the hair strands to get into the apertures 15 formed in the thinning member 14.

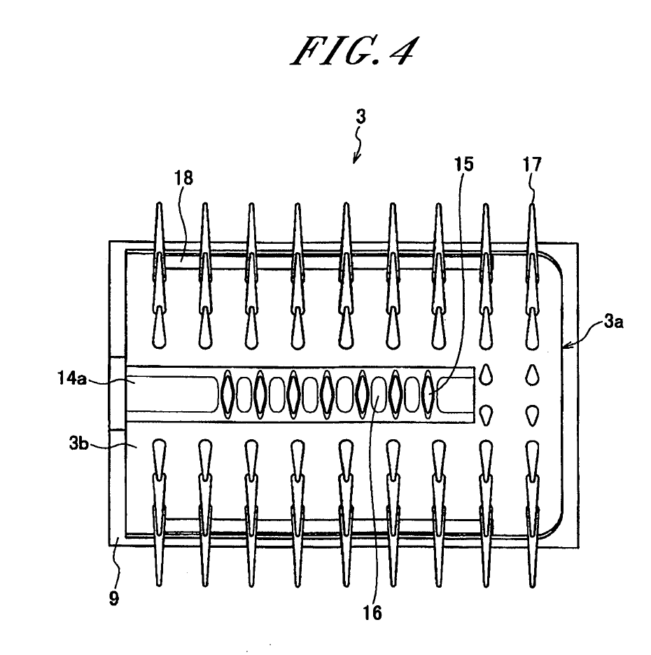

As shown in FIG. 5, the hair clipper unit 4 and the apertures 15 of the thinning member 14 are positioned higher than the outer surface 3b of the teeth holding base portion 3a so that the hair strands can be reliably introduced into the hair clipper unit 4 when they are brushed by the hair brush 1. In the hair brush 1 of the present embodiment, the specifications such as the position (height) of the hair clipper unit 4 and the apertures 15 of the thinning member 14, the curvature radius of the outer surface 3b of the teeth holding base portion 3a, the roughness of the outer surface 3b and the like are suitably adjusted from the standpoint of thinning the hair strands as well as the standpoint of brushing them.

The hair brush 1 further includes an opening-and-closing member 8 for opening and closing the apertures 15 of the thinning member 14.

In the present embodiment, the opening-and-closing member 8 is configured to close the apertures 15 of the thinning member 14 at the inner side of the thinning member 14. To this end, the opening-and-closing member 8 has two side plates 8c extending along the respective inner surfaces of the side plates 14a of the thinning member 14. The side plates 8c of the opening-and-closing member 8 are joined to each other in a rectilinear ridge portion 8d to make a substantially inverted V-shape. A suitable gap is left between the opening-and-closing member 8 and the movable blade 6 so that the opening-and-closing member 8 should not physically interfere with the movable blade 6.

A plurality of apertures (second apertures) 8a is formed in the opening-and-closing member 8. In the present embodiment, the apertures 8a are formed by cutting the side plates 8c into a substantially rectangular shape so that the apertures 8a can extend from the ridge portion 8d in a substantially perpendicular relationship with the ridge portion 8d. As shown in FIG. 2, each of the apertures 8a has a substantially rectangular shape defined by the cut-away portions joined together when seen from above the ridge portion 8d. The apertures 8a are formed substantially in the same pitch and in the same number as those of the apertures 15 of the thinning member 14.

The opening-and-closing member 8 is supported by a slide support mechanism 19 so that it can make reciprocating sliding movement along the inner wall surface of the thinning member 14. In the present embodiment, a pair of protrusion portions 14b extending in the longitudinal direction of the thinning member 14 is provided on the inner wall surfaces of the side plates 14a of thinning member 14. The opposite peripheral portions of the opening-and-closing member 8 having a substantially inverted V-like cross section are slidably placed on the respective protrusion portions 14b.

With the configuration described above, the overlapping state between the apertures 15 of the thinning member 14 and the apertures 8a of the opening-and-closing member 8 varies with the sliding position of the opening-and-closing member 8. In other words, if the apertures 15 of the thinning member 14 exactly overlap with the apertures 8a of the opening-and-closing member 8, the apertures 15 of the thinning member 14 are in a fully open state. If the apertures 15 of the thinning member 14 exactly overlap with the blocking portions 8b of the opening-and-closing member 8, the apertures 15 of the thinning member 14 are turned to a fully closed state in which the apertures 15 are closed by the blocking portions 8b of the opening-and-closing member 8. If the apertures 15 of the thinning member 14 are partially closed by the blocking portions 8b of the opening-and-closing member 8, the apertures 15 are kept in a half-open state.

In the present embodiment, the opening-and-closing member 8 is configured to make reciprocating movement together with the operation knob 7a of the operation switch 7 for changing over the operation of the driving unit.

More specifically, the operation switch 7 is provided in the substantially longitudinal center portion of the main body 2 in a substantially rectilinear alignment with the hair clipper unit 4. The operation switch 7 is provided with the operation knob 7a capable of reciprocating along the longitudinal direction of the main body 2.

The operation knob 7a is set in one of three positions, i.e., a retracted position in which the operation knob 7a lies farthest from the teeth holding base portion 3a (the operation switch 7 is turned off), an extended position in which the operation knob 7a lies closest to the teeth holding base portion 3a (the operation switch 7 is turned on) and a neutral position existing between the retracted position and the extended position (the operation switch 7 is turned on).

The operation knob 7a is connected to the opening-and-closing member 8 through a connecting rod 7b (an interlocking mechanism 21). In the present embodiment, the connecting rod 7b, the opening-and-closing member 8 and the operation switch 7 are formed as a single unit.

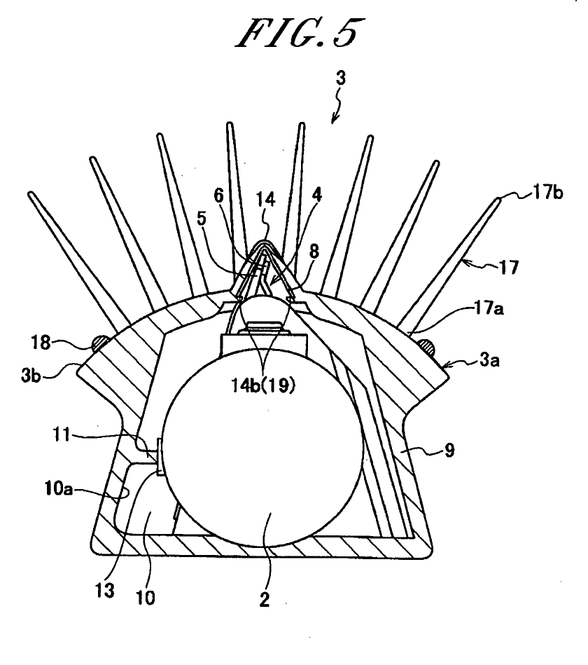

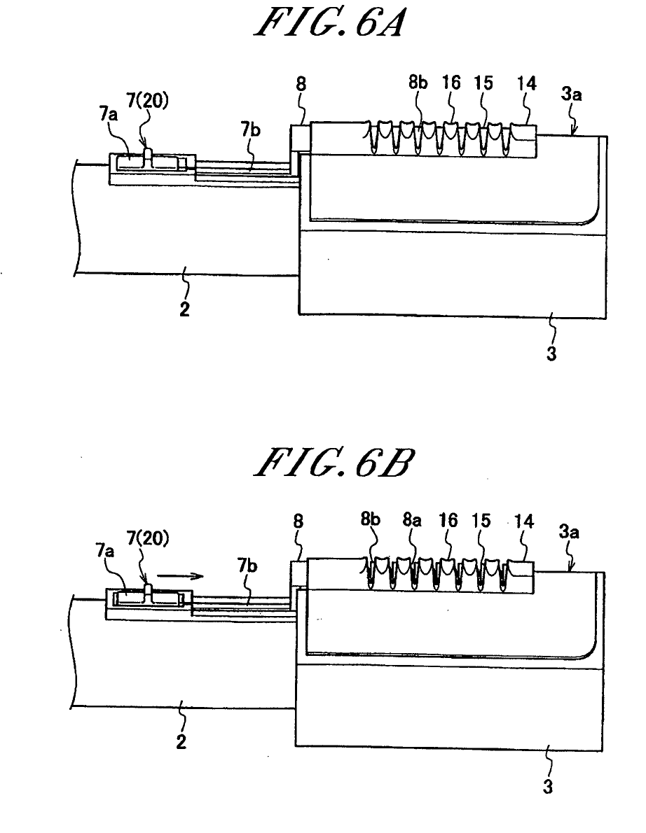

When the operation switch 7 is turned off and the operation knob 7a is moved to a first longitudinal end side (the left side in FIG. 6A) farthest from the teeth holding base portion 3a as illustrated in FIG. 6A, the opening-and-closing member 8 is positioned at a first longitudinal end side with respect to the thinning member 14. In this state, the apertures 15 of the thinning member 14 are closed by the blocking portions 8b of the opening-and-closing member 8.

If the operation switch 7 is turned on and the operation knob 7a is moved to a second longitudinal end side (the right side in FIG. 6C) closest to the teeth holding base portion 3a as illustrated in FIG. 6C, the opening-and-closing member 8 is positioned at a second longitudinal end side with respect to the thinning member 14. In this state, the apertures 15 of the thinning member 14 exactly overlap with the apertures 8a of the opening-and-closing member 8, thereby opening the substantially entire area of the apertures 15 of the thinning member 14.

In the event that the operation knob 7a is in the neutral position as illustrated in FIG. 6B, the apertures 15 of the thinning member 14 are partially closed by the blocking portion 8b of the opening-and-closing member 8 and are kept in a half-open state.

Depending on the position of the operation knob 7a, therefore, the apertures 15 of the thinning member 14 are closed or opened. Specifically, the apertures 15 of the thinning member 14 are closed by the blocking portion 8b of the opening-and-closing member 8 when the operation switch 7 is turned off and are opened through the apertures 8a of the opening-and-closing member 8 when the operation switch 7 is turned on. In addition, the area of the apertures 15 of the thinning member 14 can be changed depending on the position of the operation knob 7a when the operation switch 7 is turned on.

With the configuration described above, the opening area (opening degree) of the apertures 15 of the thinning member 14 is adjusted depending on the position where the operation knob 7a is set in the body portion of the operation switch 7. In the present embodiment, the operation switch 7 is equivalent to an opening degree adjusting mechanism 20. A conventional technique may be used as the configuration by which the operation knob 7a is fixed to (locked against) the body portion in a plurality of operation points.

In the present embodiment described above, the teeth holding base portion 3a, the fixed blade 5 and the movable blade 6 as the comb-shaped blades overlapping with each other for relative sliding movement, and the thinning member 14 covering the edges of the comb-shaped blades and having the apertures 15 are provided in the longitudinal tip end portion of the main body 2. The hair strands introduced between the blades through the apertures 15 can be clipped by reciprocating the movable blade 6 with the driving unit. Since the comb-shaped blades for thinning hair strands are provided together with the teeth holding base portion 3a, the brush teeth 17 or bristles upstanding from the teeth holding base portion 3a make it easy to secure the distance from the comb-shaped blades to the scalp.

In the present embodiment, there is provided the opening-and-closing member 8 for opening and closing the apertures 15. When the hair brush 1 is used for the sole purpose of brushing the hair without having to thin the hair, the apertures 15 of the thinning member 14 are closed by the opening-and-closing member 8. This makes it possible to smoothly move the hair brush 1.

In the present embodiment, there is provided the slide support mechanism for supporting the opening-and-closing member 8 to make sliding movement along the thinning member 14. Therefore, as compared to a case where the apertures 15 are opened and closed by rotating the opening-and-closing member 8, it is possible to reduce the space through which the opening-and-closing member 8 is moved within the teeth holding base portion 3a. This also offers an advantage in that the opening-and-closing member 8 can be operatively connected to the operation knob 7a of the operation switch 7 with ease.

In the present embodiment, there is provided the opening degree adjusting mechanism 20 for variably setting the opening degree of the apertures 15. Therefore, it is possible to control the thinning amount or clipping rate of the hair by changing the opening degree of the apertures 15 of the thinning member 14.

In the present embodiment, the opening-and-closing member 8 is configured to move at least between the open position in which to open the apertures 15 and the closed position in which to close the apertures 15. Furthermore, the hair brush 1 is configured to include the operation switch 7 for changing over the operation of the driving unit and the interlocking mechanism 21 for operatively interconnecting the operation knob 7a and the opening-and-closing member 8. Therefore, the operative connection of the opening-and-closing member 8 with the operation knob 7a enables the movable blade 6 as a comb-shaped blade to be suitably operated depending on the open-and-closed state of the apertures 15. Moreover, there is no need to provide a positioning mechanism for changing the opening and closing state between the thinning member 14 and the opening-and-closing member 8, which makes it possible to simplify the configuration of the hair brush.

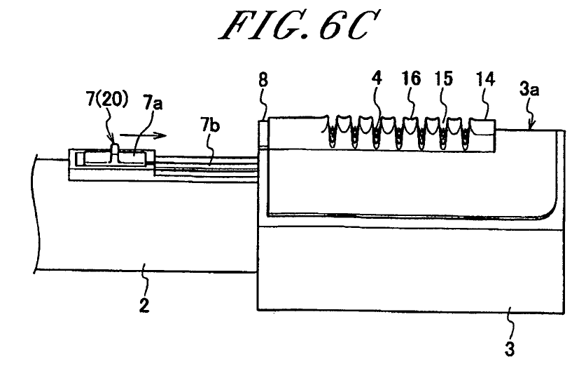

In the present embodiment, the hair strands 22 can be thinned by placing the hair brush 1 inside the hair strands 22 as illustrated in FIG. 7. This makes it possible to reduce the volume of the hair strands 22 in such a manner as to make a natural impression. In addition, it is possible to thin the hair strands while brushing and styling the hair strands. This makes it possible to clip the hair strands with a uniform length, while reducing the possibility that the thinning amount may vary from place to place.

In the present embodiment, the hair brush can be used as a hair clipper with comb-shaped blades by removing the attachment 3 from the main body 2.

While the preferred embodiment of the present invention has been described hereinabove, the present invention is not limited thereto but may be modified in many different forms.

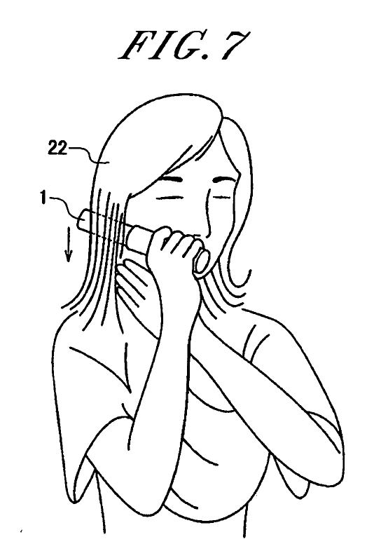

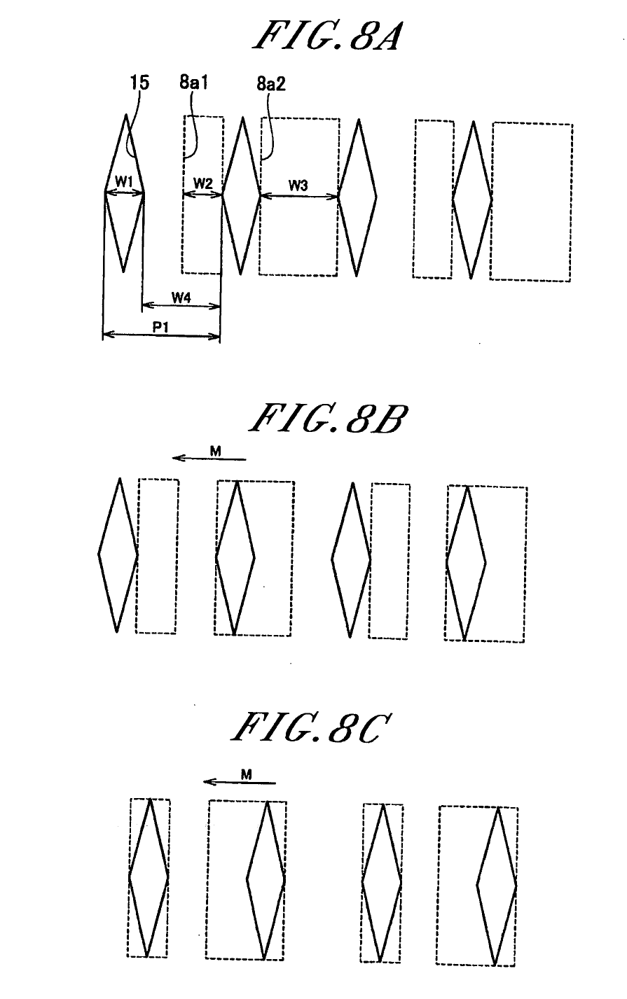

For example, the apertures 15 of the thinning member 14 may be selectively opened by adopting the layout of the apertures 15 of the thinning member 14 and the apertures 8a of the opening-and-closing member 8 as illustrated in FIGS. 8A, 8B and 8C. In other words, when the opening-and-closing member 8 is slid into a specified position, some of the apertures 15 overlap with the apertures 8a so as to come into an open state and the remaining apertures 15 are closed by the opening-and-closing member 8.

In the modified example illustrated in FIGS. 8A, 8B and 8C, the apertures 15 of the thinning member 14 are arranged along the longitudinal direction at a substantially equal interval W4 with a pitch P1 (=3×W1) three times as great as the aperture width W1.

In the opening-and-closing member 8, there are alternately formed apertures 8a1 having the same aperture width W2 (=W1) as that of the apertures 15 of the thinning member 14 and apertures 8a2 having an aperture width W3 (=2×W1) twice as great as that of the apertures 15 of the thinning member 14.

In the fully closed state illustrated in FIG. 8A, each of the apertures 8a1 is arranged at the upstream side (the right side in FIG. 8A) of the corresponding the aperture 15 of the thinning member 14 in the moving direction (the direction indicated by an arrow M) while being spaced apart from the corresponding aperture 15 by the distance equal to the aperture width W1. Each of the apertures 8a2 is arranged at the upstream side (the right side in FIG. 8A) of the corresponding apertures 15 of the thinning member 14 in the moving direction (the direction indicated by the arrow M) while being contiguous to the corresponding aperture 15.

With this configuration, if the opening-and-closing member 8 is moved from the fully closed state illustrated in FIG. 8A to the left side (in the direction indicated by the arrow M) by the distance equal to the aperture width W1, the apertures 8a1 do not overlap with the apertures 15 but the apertures 8a2 overlap with the apertures 15 as can be seen in FIG. 8B. In other words, only the apertures 15 overlapping with the apertures 8a2 are opened. This makes it possible to realize a half-open state in which the open apertures 15 and the closed apertures 15 are arranged alternately.

If the opening-and-closing member 8 is further moved from the half-open state illustrated in FIG. 8B to the left side (in the direction indicated by the arrow M) by the distance equal to the aperture width W1, it is possible to realize a fully open state in which all of the apertures 15 overlap with the apertures 8a1 and 8a2 as illustrated in FIG. 8C.

In the modified example illustrated in FIGS. 8A, 8B and 8C, the apertures 8a1 and 8a2 are alternately arranged and, therefore, the apertures 15 opened in the half-open state are arranged like the stepping-stones. It will be readily understood that the apertures 15 opened in the half-open state may be changed by modifying the layout of the apertures 8a1 and 8a2. According to this modified example, it is possible to selectively open the apertures 15 of the thinning member 14. It goes without saying that the thinning member and the opening-and-closing member of this modified example can be applied to the hair brush 1 of the foregoing embodiment.

Although the thinning unit including the hair clipper unit 4 is provided in a single point in the embodiment and the modified example described above, a plurality of thinning units may be provided in plural points. For example, the brush teeth 17 of the teeth holding base portion 3a may be arranged on the full circumferential surface of the main body 2 and a plurality of thinning units may be provided at a suitable interval along the circumferential surface of the main body 2.

While the invention has been shown and described with respect to the embodiments, it will be understood by those skilled in the art that various changes and modification may be made without departing from the scope of the invention as defined in the following claims.

What is claimed is:

1. A hair brush comprising:
a handle having a longitudinal tip end portion;
a teeth holding base portion provided in the longitudinal tip end portion of the handle;
a plurality of comb-shaped blades overlapped to make sliding contact with each other, the comb-shaped blades having edges and being provided in the longitudinal tip end portion of the handle;
a thinning member provided to cover the edges of the comb-shaped blades, the thinning member having a plurality of first apertures;
a driving unit for reciprocating at least one of the comb-shaped blades so as to clip hair strands introduced between the edges of the comb-shaped blades through the first apertures of the thinning member; and
an opening-and-closing member for opening and closing the first apertures of the thinning member.

2. The hair brush of claim 1, further comprising a slide support mechanism for supporting the opening-and-closing member so as to slide along the thinning member.

3. The hair brush of claim 2, wherein the opening-and-closing member has a plurality of second apertures, the second apertures being arranged to ensure that, when the opening-and-closing member is slid into a specified position, some of the first apertures overlap with the second apertures so as to come into an open state and the remaining first apertures are closed by the opening-and-closing member.

4. The hair brush of claim 1, further comprising an opening degree adjusting mechanism for variably setting the opening degree of the first apertures.

5. The hair brush of claim 1, further comprising a switch with an operation knob for switching the operation of the driving unit and an interlocking mechanism for operatively interconnecting the operation knob of the operation switch and the opening-and-closing member wherein the opening-and-closing member is configured to move at least between an open position in which to open the first apertures and a closed position in which to close the first apertures.

6. The hair brush of claim 2, further comprising a switch with an operation knob for switching the operation of the driving unit and an interlocking mechanism for operatively interconnecting the operation knob of the operation switch and the opening-and-closing member wherein the opening-and-closing member is configured to move at least between an open position in which to open the first apertures and a closed position in which to close the first apertures.

7. The hair brush of claim 3, further comprising a switch with an operation knob for switching the operation of the driving unit and an interlocking mechanism for operatively interconnecting the operation knob of the operation switch and the opening-and-closing member wherein the opening-and-closing member is configured to move at least between an open position in which to open the first apertures and a closed position in which to close the first apertures.

8. The hair brush of claim 4, further comprising a switch with an operation knob for switching the operation of the driving unit and an interlocking mechanism for operatively interconnecting the operation knob of the operation switch and the opening-and-closing member wherein the opening-and-closing member is configured to move at least between an open position in which to open the first apertures and a closed position in which to close the first apertures.
